(19) United States
(12) Patent Application Publication
(10) Pub. No.: US 2019/0000278 A1
(43) Pub. Date: Jan. 3, 2019

(54) CADDY AND MEAT DONENESS MARKERS ASSEMBLY

(71) Applicant: Robert E. Mancuso, Paradise Valley, AZ (US)

(72) Inventor: Robert E. Mancuso, Paradise Valley, AZ (US)

(21) Appl. No.: 16/024,892

(22) Filed: Jul. 1, 2018

Related U.S. Application Data
(60) Provisional application No. 62/521,893, filed on Jul. 3, 2017.

(51) Int. Cl. A47J 47/00; G09F 3/02

(52) U.S. Cl. CPC A47J 47/00; G09F 2003/0272; G09F 2003/0208; G09F 3/02

(57) ABSTRACT

A caddy and meat doneness markers assembly includes groups of meat doneness markers each indicating a meat doneness. The meat doneness of the meat doneness markers of each of the groups is the same and is different from the meat doneness of the meat doneness markers of each other one of the groups. A caddy includes containers holding the respective groups therein separately from one another, and indicia applied to the caddy adjacent to the containers identifying the meat doneness of the meat doneness markers of each of the respective groups.

### CROSS-REFERENCE TO RELATED APPLICATION

This application claims the benefit of U.S. Provisional Patent Application No. 62/521,893, filed Jul. 3, 2017, the entire contents of which are incorporated herein by reference.

### FIELD OF THE INVENTION

The present invention relates to doneness markers useful for indicating the doneness of meat and, more particularly, to apparatus and methods for holding and organizing doneness markers.

### BACKGROUND OF THE INVENTION

It is known to provide meat doneness markers for marking the doneness of cuts of meat. Meat doneness markers are commonly used in restaurants and cafeterias to enable cooks to mark the doneness of the cuts of meat they cook to prevent confusion amongst cooked cuts of meat and to ensure customers are provided with meat cooked to order. Although meat doneness markers serve an important purpose and are widely used, they are difficult to handle and store for convenient and efficient access. If fact, different doneness markers are often stored together, requiring the cook to shuffle through the markers until the correct one is found, which is time consuming and frustrating. Given these and other deficiencies in the art, the need for certain new and useful improvements is evident.

### SUMMARY OF THE INVENTION

According to the principle of the invention, a caddy and meat doneness markers assembly includes groups of meat doneness markers each indicating a meat doneness, the meat doneness of the meat doneness markers of each of the groups is the same and is different from the meat doneness of the meat doneness markers of each other one of the groups, a caddy including containers removably holding the respective groups therein separately from one another, and indicia applied to the caddy adjacent to the containers identifying the meat doneness of the meat doneness markers of each of the respective groups. The containers are in-line, the meat doneness markers of the groups extend outwardly from the respective containers to enable the meat doneness markers of the groups to be taken up and removed from the respective containers by hand, and the containers are upright and hold the meat doneness markers upright therein.

According to the principle of the invention, a method includes providing groups of meat doneness markers each indicating a meat doneness, the meat doneness of the meat doneness markers of each of the groups is the same and is different from the meat doneness of the meat doneness markers of each other one of the groups, providing a caddy including containers and indicia applied to the caddy adjacent to the containers identifying the meat doneness of the meat doneness markers of each one of the respective groups, and placing the groups of the meat doneness markers into the respective containers according to the indicia. The containers are in-line, the meat doneness markers of the groups extend outwardly from the respective containers to enable the meat doneness markers of the groups to be taken up and removed from the respective containers by hand, and the containers are upright and hold the meat doneness markers upright therein.

### BRIEF DESCRIPTION OF THE DRAWINGS

Referring to the drawings:

FIG. 1 is a perspective view of a caddy and meat doneness markers assembly according to the principle of the invention;

FIG. 2 is a front elevation view of the embodiment of FIG. 1;

FIG. 3 illustrates meat doneness markers and a skewer, a form of a utility pick, according to the prior art and which form part of the assembly of the embodiment of FIGS. 1 and 2;

FIGS. 4 and 5 are top perspective view of the caddy first illustrated in FIG. 1 shown as it would appear empty;

FIG. 6 is a bottom perspective view of the embodiment of FIGS. 4 and 5;

FIG. 7 is a section view taken along line 7-7 of FIG. 5;

FIG. 8 is a section view taken along line 8-8 of FIG. 5; and

FIG. 9 is a view like FIG. 7 illustrating the caddy as it would appear charged with meat doneness markers and skewers as in FIGS. 1 and 2.

### DETAILED DESCRIPTION

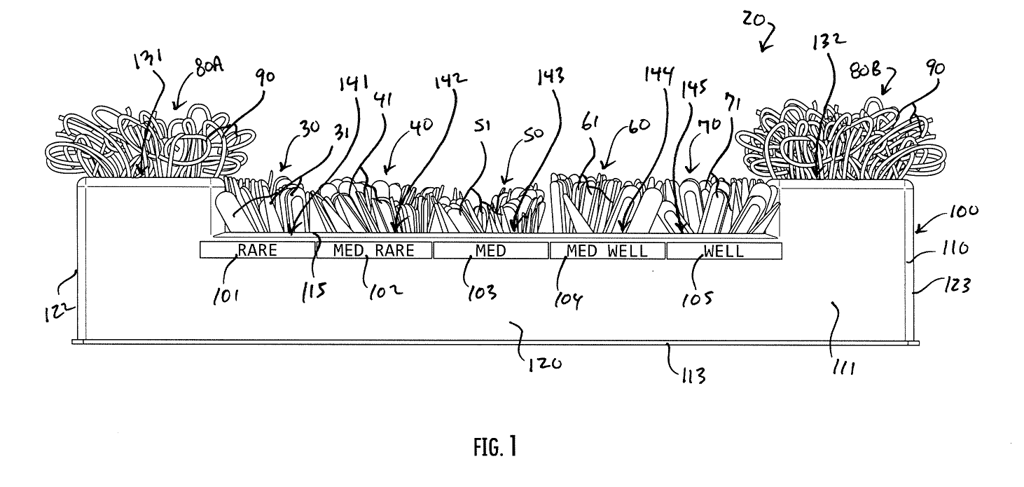

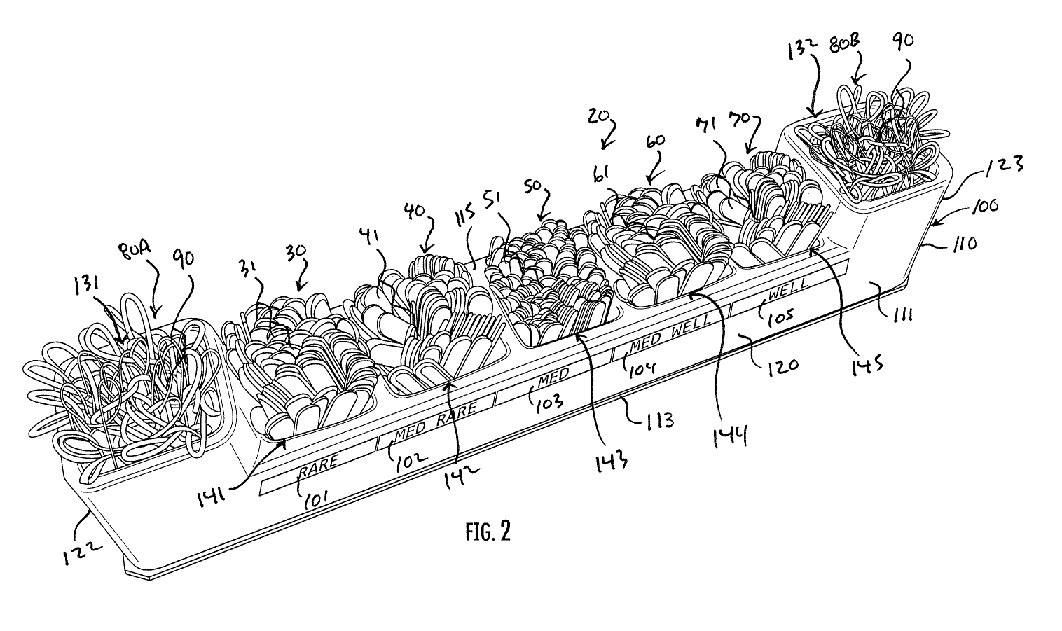

Turning now to the drawings, in which like reference characters indicate corresponding elements throughout the several views, attention is first directed to FIGS. 1 and 2 illustrating a caddy and meat doneness markers assembly 20 according to the principle of the invention including groups 30, 40, 50, 60, and 70 of meat doneness markers 31, 41, 51, 61, and 71, respectively, groups 80A and 80B of skewers 90, and caddy 100 removably holding groups 30, 40, 50, 60, 70, 80A, and 80B therein separately from one another. Markers 31 of group 30 are identical and conventional and each indicate or otherwise identify a meat doneness, markers 41 of group 40 are identical and conventional and each indicate or otherwise identify a meat doneness, markers 51 of group 50 are identical and conventional and each indicate or otherwise identify a meat doneness, markers 61 of group 60 are identical and conventional and each indicate or otherwise identify a meat doneness, and markers 71 of group 70 are identical and conventional and each indicate or otherwise identify a meat doneness. Markers 31 of group 30 indicate or otherwise identify the same meat doneness, markers 41 of group 40 indicate or otherwise identify the same doneness, markers 51 of group 50 indicate or otherwise identify the same meat doneness, markers 61 of group 60 indicate or otherwise identify the same meat doneness, and markers 71 of group 70 indicate or otherwise identify the same meat doneness, and the meat donenesses of the groups 30, 40, 50, 60, and 70 of respective markers 31, 41, 51, 61, and 71, are different from one another. The meat doneness of markers 31 can be referred to as a first meat doneness, the meat doneness of markers 41 can be referred to as a second meat doneness, the meat doneness of markers 51 can be referred to as a third meat doneness, the meat doneness of markers 61 can be referred to as a fourth meat doneness, and the meat doneness of markers 71 can be referred to as a fifth meat doneness, in which the first meat doneness, the second meat doneness, the third meat doneness, the fourth meat doneness, and the fifth meat doneness are different from one another.

Indicia 101 applied to caddy 100 adjacent to group 30 indicates or otherwise identifies the meat doneness indicated or otherwise identified by markers 31 of group 30, indicia 102 applied to caddy 100 adjacent to group 40 indicates or otherwise identifies the meat doneness indicated or otherwise identified by markers 41 of group 40, indicia 103 applied to caddy 100 adjacent to group 50 indicates or otherwise identifies the meat doneness indicated or otherwise identified by markers 51 of group 50, indicia 104 applied to caddy 100 adjacent to group 60 indicates or otherwise identifies the meat doneness indicated or otherwise identified by markers 61 of group 60, and indicia 105 applied to caddy 100 adjacent to group 70 indicates or otherwise identifies the meat doneness indicated or otherwise identified by markers 71 of group 70. Indicia 101-105 are each doneness indicia.

In assembly 20, groups 30, 40, 50, 60, 70, 80A and 80A are held separately by caddy 100 in-line, and meat doneness markers 31, 41, 51, 61, and 71 and skewers 90 of the respective groups 30, 40, 50, 60, 70, 80A, and 80B extend upright and outwardly from caddy 100, to enable meat doneness markers 31, 41, 51, 61, and 71 of the respective groups 30, 40, 50, 60, and 70 to be selectively taken up by hand and removed from caddy 100 and selectively inserted into cooked meat for indicating the doneness thereof, and to enable skewers 90 of the respectively groups 80A and 80B to be selectively taken up by hand and removed from caddy 100 and selectively inserted through meat or other food to hold or bind it, such as for serving or cooking. Assembly 20 is useful by restaurant cooks at food preparation work stations for efficiently organizing the various markers and skewers, and enabling skilled cooks to efficiently and easily access the various markers for selectively marking the doneness of meat and to efficiently and easily access the skewers for selecting skewering food. In the present embodiment, there are approximately fifty markers 31 in group 30, approximately fifty markers 41 in group 40, approximately fifty markers 51 in group 50, approximately fifty markers 61 in group 60, approximately fifty markers 71 in group 70, and approximately fifty skewers 90 in each of groups 80A and 80B, and less or more can be employed in each one of the groups depending on specific needs.

The term “doneness” is known by the skilled person, the skilled cook in this case, as a gauge of how thoroughly cooked a cut of meat is based on color, juiciness, and internal temperature when cooked. The gradations of cooking are most often used in reference to beef, especially steaks and roasts, but are also applicable to lamb, pork, poultry, veal and seafood. Standard doneness gradations known in the art rare, medium rare, medium, medium well, and well done, the details of which are well known to the skilled cook and are not discussed in detail. Markers 31, 41, 51, 61, and 71 are configured to indicate or otherwise identify the foregoing standard donenesses, respectively.

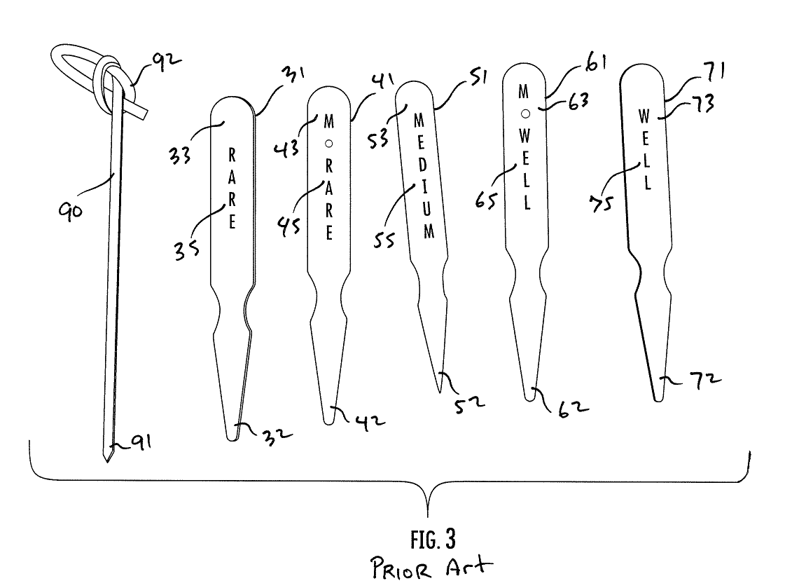

Markers 31 are identical, markers 41 are identical, markers 51 are identical, markers 61 are identical, markers 71 are identical, and skewers 90 are identical. FIG. 3 illustrates one marker 31 of group 30 in FIGS. 1 and 2, one marker 41 of group 40 in FIGS. 1 and 2, one marker 51 of group 50 in FIGS. 1 and 2, one marker 61 of group 60 in FIGS. 1 and 2, one marker 71 of group 70 in FIGS. 1 and 2, and one skewer 90 of one of groups 80A and 80B in FIGS. 1 and 2. Markers 31, 41, 51, 61, and 71 are configured to indicate or otherwise identify their respective different donenesses with indicia 35, 45, 55, 65, and 75, each being something of a kind, written or otherwise, that may be observed and understood or otherwise perceptible to the senses or to reason or understanding for communicating a doneness. In this manner, each indicia 35, 45, 55, 65, and 75 is a kind suitable to be observed and then perceived or understood as a particular doneness. Indicia 35, 45, 55, 65, and 75 are each doneness indicia. Markers 31, 41, 51, 61, and 71 are each conventionally made of a food-grade material, such as plastic, wood, or the like. Marker 31 is elongate and has pointed piercing end 32 and opposed handled end 33, marker 42 is elongate and has pointed piercing end 42 and opposed handled end 43, marker 51 is elongate and has pointed piercing end 52 and opposed handled end 53, marker 61 is elongate and has pointed piercing end 62 and opposed handled end 63, and marker 71 is elongate and has pointed piercing end 72 and opposed handled end 73. In this example, indicia 35 of marker 31 is the writing “RARE” meaning a doneness of rare, indicia 45 of marker 41 is the writing “M RARE” meaning a doneness of medium rare, indicia 55 of marker 51 is the writing “MEDIUM” meaning a doneness of medium, indicia 65 of marker 61 is the writing “M WELL” meaning a doneness of medium well, and indicia 75 of marker 71 is the writing “WELL” meaning a doneness of well. Accordingly, each marker 31 of group 30 is configured to indicate or otherwise identify a doneness of “rare,” each marker 41 of group 40 is configured to indicate or otherwise identify a doneness of “medium rare,” each marker 51 group 50 is configured to indicate or otherwise identify a doneness of “medium,” each marker 61 of group 60 is configured to indicate or otherwise identify a doneness of “medium well,” and each marker 71 of group 70 is configured to indicate or otherwise identify a doneness of “well.” Other chosen wordings for the described indicia can be used to indicate or otherwise identify the various donenesses. The markers of the various groups 30-70 clearly indicate or otherwise identify donenesses that are different from one another, in which the doneness indicated by each marker of each group is the same and is different from each marker of each remaining group. In this example, indicia 35 of marker 31 is imprinted on handled end 33, indicia 45 of marker 41 is imprinted on handled end 43, indicia 55 of marker 51 is imprinted on handled end 53, indicia 65 of marker 61 is imprinted on handled end 63, and indicia 75 of marker 71 is imprinted on handled end 73. The indicia of the various markers can be applied thereto in other ways, such as by molding, stamping, or other technique known in the art of meat doneness markers. In standard use, each marker is pierced piercing end first into a cut of meat cooked to a doneness according to the doneness of the given marker in order to anchor the marker therein to identify the doneness of the given cut of meat via the doneness indicia applied to the handled end of the marker.

Skewer 90 in FIG. 3, a form of a utility pick, is elongate and has a pointed skewering end 91 and an opposed handled end 92 and is a conventional cocktail skewer fashioned in this example of bamboo, although plastic or other chosen material or combination of material can be used. Food is skewered onto each skewer 90 from the skewering end 91.

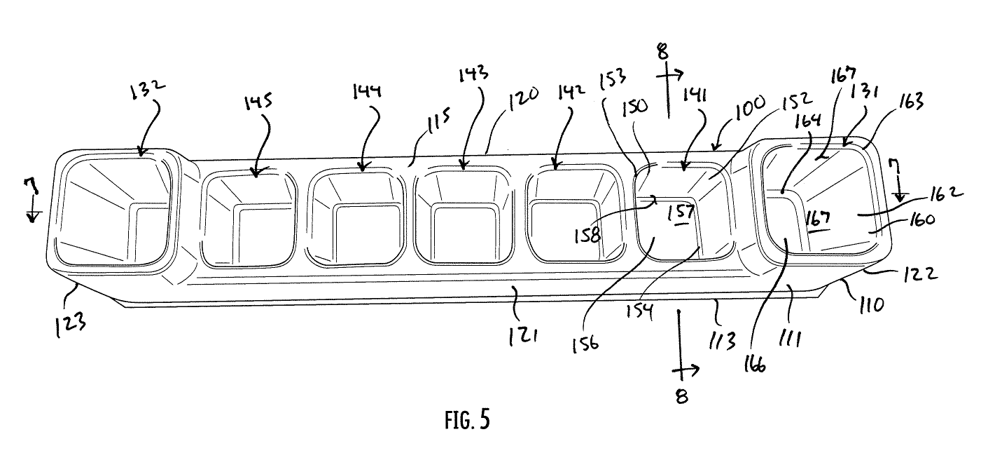

Referring in relevant part to FIGS. 1, 2, and 4-6, caddy 100 is a body fashioned of wood, metal, plastic, carbon fiber, fiberglass or other material or combination of materials having the properties of rigidity, flexibility, resilience, and impact resistance, and is preferably integrally formed being a unitary structure. Caddy 100 includes continuous sidewall 110 having outer surface 111, inner surface 112, and lower edge 63. Continuous sidewall 110 is elongate and includes opposed sides 120 and 121 that extend between opposed ends 122 and 123. Side 120 is considered the front of caddy 100, and side 121 is considered the back of caddy 100.

Caddy 110 is formed with containers, including container 131 proximate to end 122, container 132 proximate to end 123, and containers 141, 142, 143, 144, and 145 therebetween. Containers 131, 141, 142, 143, 144, 145 and 132 are cups and are in-line from end 122 to end 123. Continuous sidewall 110 extends upright from lower edge 112 to upper extremity 115 from which containers 131, 141, 142, 143, 144, 145 and 132 depend downwardly therefrom. Containers 141, 142, 143, 144, and 145 are in-line from container 131 at end 122 of caddy 100 to container 132 at end 123 of caddy 100. Containers 141, 142, 143, 144, and 145 are identical and container 141 will now be discussed, with the understanding that the ensuing discussion of container 141 applies in every respect to the remaining containers 142, 143, 144, and 145.

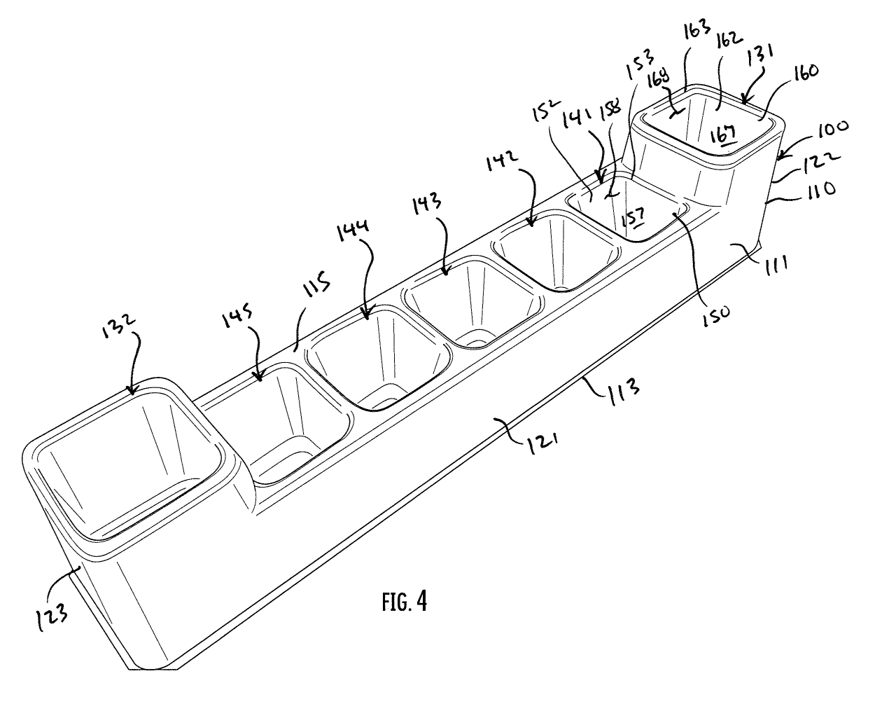

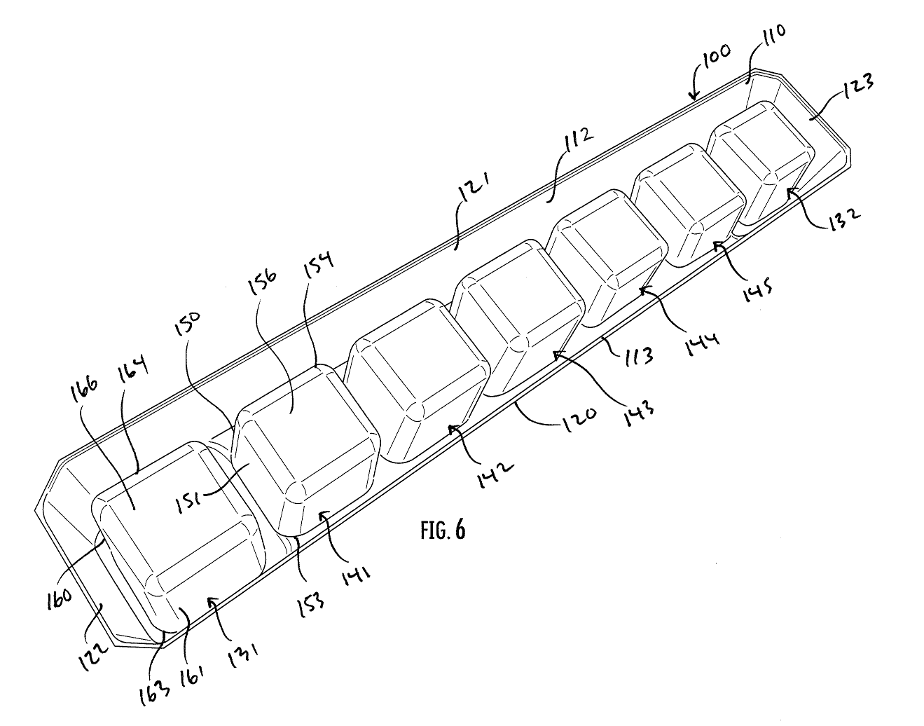

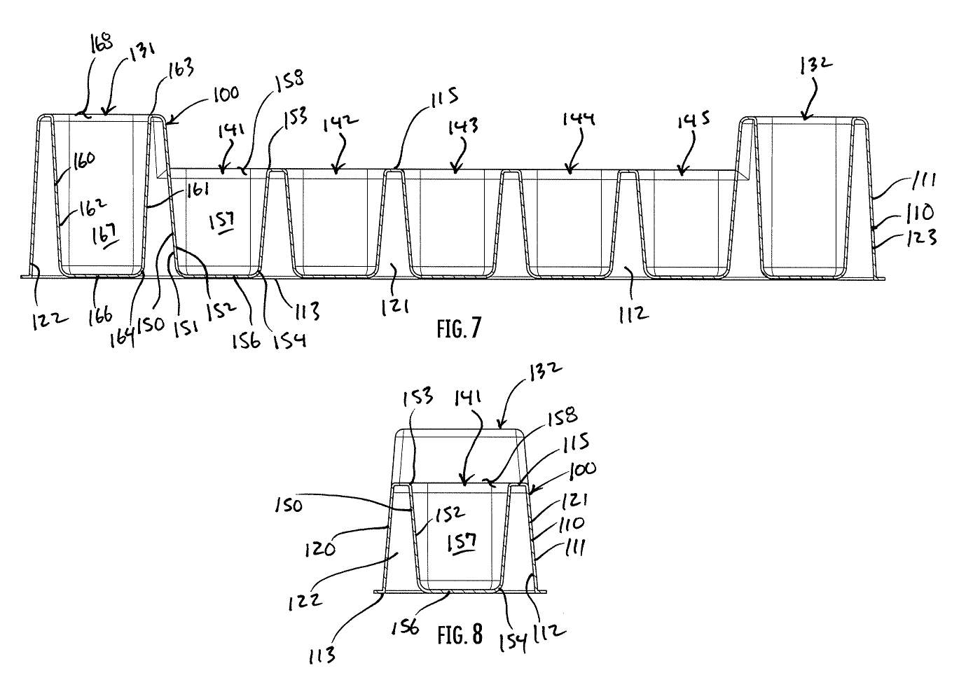

With continuing reference in relevant part to FIGS. 4-9, container 141, a cup, includes continuous sidewall 150 having outer surface 151, inner surface 152, upper edge 153, and lower edge 154. Horizontal bottom 156 is affixed to lower edge 154. Bottom 156 cooperates with inner surface 152 of continuous sidewall 150 to form volume 157. Upper edge 153 encircles opening 158 to volume 157. Volume 157 is for receiving contents placed therein, group 30 of markers 31 in this example, through opening 158. Continuous sidewall 150, and thus container 141, is upright from bottom 156 to upper edge 153 encircling opening 158 to volume 157 between sides 120 and 121. Continuous sidewall 150 depends downwardly from upper edge 153, affixed integrally to upper extremity 115 between sides 120 and 121 and between ends 122 and 123, to bottom 156, which is substantially flush with lower edge 113 of continuous sidewall 110, in which bottom 156 of container 141 does not extend beyond lower edge 113. Container 141 has a height from bottom 156 to opening 158 at upper edge 153.

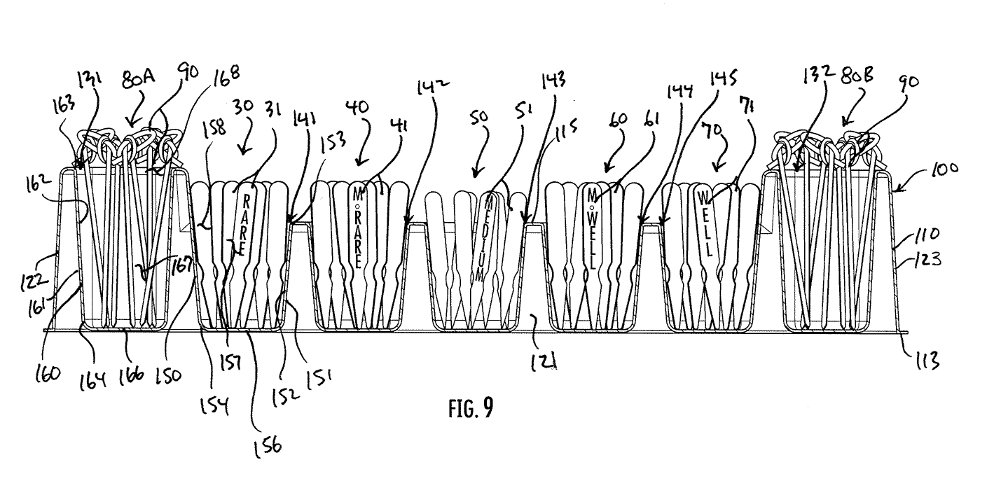

In FIG. 9, markers 31 of group 30 are longer than the height of container 141, and are otherwise sufficiently long to extend upright through volume 157 of container 141 from supported against bottom 156 to opening 158 at upper extremity 115 and outwardly from and beyond opening 158 and upper extremity 115 of caddy 100 to enable markers 31 to be selectively taken up by hand and removed from container 141 of caddy 100 and selectively inserted piercingly into cooked meat for indicating the doneness thereof, when group 30 of markers 31 is placed into and held by container 141. Identically, container 142 is for receiving and holding group 40 of markers 41, container 143 is for receiving and holding group 50 of markers 51, container 144 is for receiving and holding group 50 of markers 51, and container 145 is for receiving and holding group 70 of markers 71. Identically to markers 31 of group 30 and container 141, markers 41 of group 40 are longer than the height of container 142 and are otherwise longer than the height of container 142 and are sufficiently long to extend upright through container 142 and outwardly from and beyond upper extremity 115 of caddy 100 when group 40 of markers 41 is placed into and held by container 142, markers 51 of group 50 are longer than the height of container 143 and are otherwise sufficiently long to extend upright through container 143 and outwardly from and beyond upper extremity 115 of caddy 100 when group 50 of markers 51 is placed into and held by container 142, markers 61 of group 60 are longer than the height of container 144 and are otherwise sufficiently long to extend upright through container 144 and outwardly from and beyond upper extremity 115 of caddy 100 when group 60 of markers 61 is placed into and held by container 144, and markers 71 of group 70 are longer than the height of container 145 and are otherwise sufficiently long to extend upright through container 145 and outwardly from and beyond upper extremity 115 of caddy 100 when group 70 of markers 71 is placed into and held by container 145, enabling the various markers to be selectively taken up by hand and removed from the respective containers 141-145 of caddy 100 and selectively inserted into cooked meat for indicating the doneness thereof. The various markers can be placed into the respective containers/cups 141-145 piercing end down or handled end down against the respective container bottoms.

Containers 131 and 132 are identical and container 131 will now be discussed, with the understanding that the ensuing discussion of container 131 applies in every respect to container 132. With continuing reference in relevant part to FIGS. 4-9, container 131, a cup, includes continuous sidewall 160 having outer surface 161, inner surface 162, upper edge 163, and lower edge 164. Horizontal bottom 166 is affixed to lower edge 164. Bottom 166 cooperates with inner surface 162 of continuous sidewall 160 to form volume 167. Upper edge 163 encircles opening 168 to volume 167. Volume 167 is for receiving contents placed therein, group 80A of skewers 90 in this example, through opening 168. Continuous sidewall 160 is upright from bottom 166 to upper edge 163 encircling opening 168 to volume 167 between sides 120 and 121. Continuous sidewall 160 depends downwardly from upper edge 163, affixed integrally to upper extremity 115 between sides 120 and 121 and between end 122 and container 141, to bottom 166, which is substantially flush with lower edge 113 of continuous sidewall 110, in which bottom 166 of container 131 does not extend beyond lower edge 113. Container 131 has a height from bottom 166 to opening 168 at upper edge 163. Container 132 is identical to container 131 and is between sides 120 and 121 and between end 123 and container 145. In this example, the height of containers 131 and 132 is greater than the height of containers 141-145 and this is clearly shown in the various figures.

In FIG. 9, skewers 90 of group 80A are longer than the height of container 131, and are otherwise sufficiently long to extend upright through volume 167 of container 131 from supported against bottom 166 to opening 168 at upper extremity 115 and outwardly from and beyond opening 168 and upper extremity 115 of caddy 100 to enable skewers 90 to be selectively taken up by hand and removed from container 131 of caddy 100 and used to selectively skewer food, when group 80A of skewers 90 is placed into and held by container 131. Identically, container 132 is for receiving and holding group 80B of skewers 90. Identically to skewers 90 of group 80A and container 131, skewers 90 of group 80B are longer than the height of container 132, and are otherwise sufficiently long extend upright through container 132 and outwardly from upper extremity 115 of caddy 100 when group 80B of skewers 90 is placed into and held by container 132, enabling skewers 90 of group 80B to be selectively taken up by hand and removed from container 132 and used to selectively skewer food. Skewers 90 are preferably placed into the respective containers 131 and 132 skewering end down. Skewers 90 are longer than markers 31, 41, 51, 61, and 71. Accordingly, containers 131 and 132 are equal in height and are greater in height compared to containers 141-145 to accommodate the greater relative height of skewers 90.

In FIGS. 1 and 2, indicia 101 is applied to outer surface 111 of side 120 of caddy 100 adjacent to container 141 proximate to upper extremity 115, indicia 102 is applied to outer surface 111 of side 120 of caddy 100 adjacent to container 142 proximate to upper extremity 115, indicia 103 is applied to outer surface 111 of side 120 of caddy 100 adjacent to container 143 proximate to upper extremity 115, indicia 104 is applied to outer surface 111 of side 120 of caddy 100 adjacent to container 144 proximate to upper extremity 115, and indicia 105 is applied to outer surface 111 of side 120 of caddy 100 adjacent to container 145 proximate to upper extremity 115. Indicia 101-105, doneness indicia, are carried by caddy 100 in-line from container 141 to container 145, and are each something of a kind, written or otherwise, that may be observed and understood or otherwise perceptible to the senses or to reason or understanding for communicating a doneness. In this manner, indicia 101-105 are each a kind suitable to be observed and then perceived or understood as a particular doneness.

Indicia 101 applied to caddy 100 adjacent to container 141 indicates or otherwise identifies the meat doneness indicated or otherwise identified by markers 31 of group 30, indicia 102 applied to caddy 100 adjacent to container 142 indicates or otherwise identifies the meat doneness indicated or otherwise identified by markers 41 of group 40, indicia 103 applied to caddy 100 adjacent to container 143 indicates or otherwise identifies the meat doneness indicated or otherwise identified by markers 51 of group 50, indicia 104 applied to caddy 100 adjacent to container 144 indicates or otherwise identifies the meat doneness indicated or otherwise identified by markers 61 of group 60, and indicia 105 applied to caddy 100 adjacent to container 145 indicates or otherwise identifies the meat doneness indicated or otherwise identified by markers 71 of group 70. In this example, indicia 101 of caddy 100 is the writing “RARE” meaning a doneness of rare, indicia 102 of caddy 100 is the writing “MED RARE” meaning a doneness of medium rare, indicia 103 of caddy 100 is the writing “MED” meaning a doneness of medium, indicia 104 of caddy 100 is the writing “MED WELL” meaning a doneness of medium well, and indicia 105 of caddy 100 is the writing “WELL” meaning a doneness of well. Other chosen wordings for the described indicia can be used to indicate or otherwise identify the various donenesses. In this example, indicia 101-105 are imprinted on outer surface 111 of side 120, the front side of caddy 100, and indicia 101-105 can be applied to caddy 110 in other ways, such as by molding, stamping, adhesive labels, or other chosen technique.

As disclosed herein, indicia 101 applied to caddy 100 adjacent to group 30 indicates or otherwise identifies the meat doneness indicated or otherwise identified by markers 31 of group 30, indicia 102 applied to caddy 100 adjacent to group 40 indicates or otherwise identifies the meat doneness indicated or otherwise identified by markers 41 of group 40, indicia 103 applied to caddy 100 adjacent to group 50 indicates or otherwise identifies the meat doneness indicated or otherwise identified by markers 51 of group 50, indicia 104 applied to caddy 100 adjacent to group 60 indicates or otherwise identifies the meat doneness indicated or otherwise identified by markers 61 of group 60, and indicia 105 applied to caddy 100 adjacent to group 70 indicates or otherwise identifies the meat doneness indicated or otherwise identified by markers 71 of group 70. To assemble assembly in FIGS. 1, 2, and 9 according to an exemplary method, group 30 of markers 31 is provided and is placed into container 141, group 40 of markers 41 is provided and is placed into container 142, group 50 of markers 51 is placed into container 13, group 60 of markers 61 is provided and is placed into container 144, group 70 of markers 71 is provided and is placed into container 145, group 80A of skewers 90 is provided and is placed into container 131, and group 80B of skewers 90 is provided and is placed into container 132, in which groups 30-80 are held separately from one another, and markers 31 of group 30, markers 41 of group 40, markers 51 of group 50, markers 61 of group 60, markers 71 of group 70, and skewers 90 of groups 80A and 80B extend upright through the respective containers of caddy 100 and outwardly from and beyond upper extremity 115 of caddy 100, enabling the various markers to be selectively taken up by hand and removed from the respective containers 141-145 of caddy 100 and selectively piercingly inserted into cooked cuts of meat for indicating the doneness thereof, and enabling skewers 90 of groups 80A and 80B to be selectively taken up by hand and removed from the respective containers 131 and 132 and used to selectively skewer food. The assembly of caddy 100 and groups 30-80 form assembly 20 that is useful by restaurant cooks at food preparation work stations for efficiently organizing the various markers and skewers, and enabling skilled cooks to efficiently and easily access the various markers for selectively marking the doneness of meat and to efficiently and easily access the skewers for selecting skewering food.

In use, assembly 20 is set lower edge 113 down onto supporting surface, such as a counter, shelf, etc., adjacent to a food-preparation area directing the front of caddy 100, side 120, toward the food-preparation area for enabling indicia 101-105 to be easily viewed by the skilled worker preparing food at the food-preparation area. The doneness labeling provided by indicia 101-105 arranged in-line from left-to-right in this example from container 141 adjacent to container 131 at end 122 of caddy 100 to container 145 adjacent to container 132 at end 123 of caddy 100 enable the skilled worker to readily visually access indicia 101-105 and visually identify and accurately access the markers 31-71 of the various groups 30-70 as needed for using the various markers to piercingly mark the doneness levels of cuts of meat without having to look elsewhere for the markers and without having to haphazardly shuffle through mismatched markers until the correct marker is found. The arrangement of groups 30, 40, 50, 60, 70, 80A and 80A held separately by containers 141, 142, 143, 144, 145, 131, and 132 of caddy 100 in-line and the corresponding in-line arrangement containers 141, 142, 143, 144, and 145 and groups 30, 40, 50, 60, and 70 herein therein and also indicia 101-105 labeling the doneness of the markers of the various groups provide an efficient in-line display of the various groups of markers in conjunction with corresponding indicia 101-105 from container 131 holding group 80A of skewers 90 to container 132 holding group 80B of skewers 90. As needed, skewers 90 of groups 80A and 80B on either side of groups 30 and 70, respectively, can be selectively taken up by hand and removed from caddy 100 and selectively inserted through meat or other food to hold or bind it, such as for serving or cooking. The markers and skewers of the various groups of assembly 20 can be replenished as needed.

The present invention is described above with reference to illustrative embodiments. However, those skilled in the art will recognize that changes and modifications may be made in the described embodiments without departing from the nature and scope of the present invention. Various further changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Apparatus, comprising:
groups of meat doneness markers each indicating a meat doneness, the meat doneness of the meat doneness markers of each of the groups is the same and is different from the meat doneness of the meat doneness markers of each other one of the groups;
a caddy including containers removably holding the respective groups therein separately from one another; and
indicia applied to the caddy adjacent to the containers identifying the meat doneness of the meat doneness markers of each of the respective groups.

2. The apparatus according to claim 1, wherein the containers are in-line.

3. The apparatus according to claim 1, wherein the meat doneness markers of the groups extend outwardly from the respective containers to enable the meat doneness markers of the groups to be taken up and removed from the respective containers by hand.

4. The apparatus according to claim 3, wherein the containers are upright and hold the meat doneness markers upright therein.

5. A method, comprising:
providing groups of meat doneness markers each indicating a meat doneness, the meat doneness of the meat doneness markers of each of the groups is the same and is different from the meat doneness of the meat doneness markers of each other one of the groups;
providing a caddy including containers and indicia applied to the caddy adjacent to the containers identifying the meat doneness of the meat doneness markers of each one of the respective groups; and
placing the groups of the meat doneness markers into the respective containers according to the indicia.

6. The method according to claim 5, wherein the containers are in-line.

7. The method according to claim 5, wherein the meat doneness markers of the groups extend outwardly from the respective containers to enable the meat doneness markers of the groups to be taken up and removed from the respective containers by hand.

8. The method according to claim 7, wherein the containers are upright and hold the meat doneness markers upright therein.
